(19) United States
(12) Patent Application Publication
(10) Pub. No.: US 2015/0310836 A1
(43) Pub. Date: Oct. 29, 2015

(54) RHYTHM BRIDGE FOR VIOLIN

(71) Applicant: Andrew Edward Isherwood, Houston, TX (US)

(72) Inventor: Andrew Edward Isherwood, Houston, TX (US)

(21) Appl. No.: 14/265,276

(22) Filed: Apr. 29, 2014

(51) Int. Cl. G10D 3/04

(52) U.S. Cl. CPC G10D 3/04

(57) ABSTRACT

One embodiment of a bridge having a planed top and notches set in a straight line, for use with stringed instruments of the violin type. The bridge is commonly made out of wood or alternative materials used in manufacturing.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

This application generally relates to bridges made for stringed instruments, specifically to bridges designed for instruments of the violin family.

2. Prior Art

A violin in today's world invariably has a bridge that is curved. This allows the player the ability to play each string one or two at a time while sacrificing the ability to play all strings at once, a feature guitars have due to the flat bridge on the lower portion of the guitar. There were a few attempts to create a bridge that gave a violin player the ability to bow across all four strings on a violin simultaneously, none of which are in common use today.

U.S. Pat. No. 1,377,570 to Fisher (1921) discloses a violin bridge with a complex mechanism of levers controlling pegs underneath each of the strings. These pegs move upward in accordance with the levers to maneuver the strings onto a flat plane. Unfortunately, this was not only dangerous to the strings and the violin, as they could snap off due to the additional tension gained by lifting the pegs, but the capability to construct the bridge itself was outside the general capacity of most bridge makers. As no exposure of the invention was made, nor was it ever manufactured by anyone besides the inventor himself, ultimately it was a commercial failure.

U.S. Pat. No. 1,625,538 to Rupert (1927) discloses an experimental bridge for the cello that has a completely flat bridge. However, this bridge was made out of metal and connected to a large horn. This made his instrument very difficult for anyone else to manufacture and it did not gain significant attention in the public eye.

The composer Ole Bull (1810-1880) modified a violin bridge to be much less curved than other bridges, allowing him the ability to play more than two strings at a time while keeping the ability to play each string individually. While this was effective for solo performances, unfortunately playing all four strings at once required an excessive amount of downward pressure from the bow which would wear down both the bow and the strings much more quickly than on a normal violin. It was almost exclusively used by himself and isn't very well documented.

The Hungarian kontra is an offshoot of the viola, similar to a violin in shape but is larger and plays lower notes. The kontra itself has only three strings (compared to the usual four) and has a flat bridge, allowing the player to bow across all three strings. While this is easier than playing across four strings, it makes the instrument much less versatile and makes it harder to play certain lead sections in songs. The bridge itself, being made for a viola, is larger and has a different shape compared to the Rhythm Bridge, which is designed for the violin.

Additionally, the starting bridge materials used by luthiers are sometimes manufactured and sold wholesale with a flat top surface. These are unfinished products and are subsequently cut to size by luthiers prior to use. Though they may include typical bridge feet and a flat top, these are not working bridges; they are impossible to play on, as they have no notches for strings, and are never used for performance, but are rounded and notched by a luthier prior to installation on a violin.

### SUMMARY

In accordance with one embodiment, a bridge is planed on the top side and appropriate notches are set in the upper portion.

### DRAWINGS

### Figures

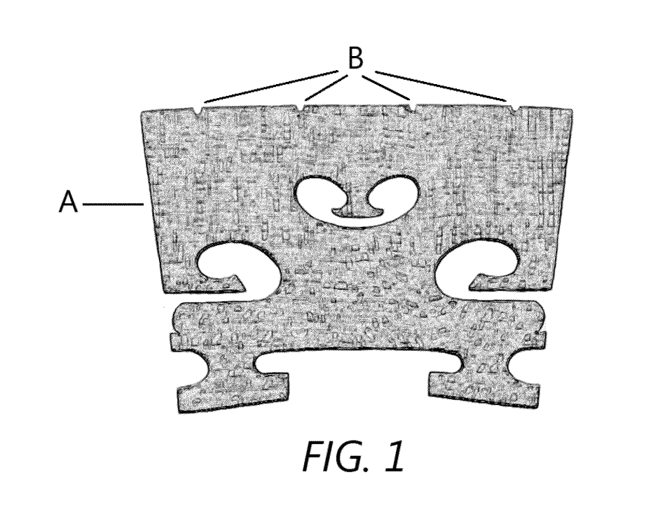

FIG. 1 shows a front view of an embodiment of the Rhythm Bridge (A), and on its top are four notches (B) set in a single plane.

### DETAILED DESCRIPTION

### FIG. 1—First Embodiment

In the preferred embodiment, the bridge is typically made out of maple wood. Its top side is planed and notched. There are four small notches in the top side, spaced evenly without any being lower or higher than the rest. It has a base with two feet, which are designed to fit the curved surface of an instrument. The bridge's depth tapers, measuring at approximately 5 mm depth at its base, to approximately 2 mm depth at its top.

ABSTRACT: One embodiment of a bridge having a planed top and notches set in a straight line, for use with stringed instruments of the violin type. The bridge is commonly made out of wood or alternative materials used in manufacturing.

### Operation—FIG. 1

The bridge is the device that supports all the strings on a stringed instrument and transmits the vibration of the strings to the body of the instrument in order to transfer the sound to the surrounding air. When the bow is dragged along the string(s) horizontally, the string(s) that are in contact with the bow vibrate and produce sound. With this embodiment, a bow can vibrate one, two, three, or four strings at once.

Having described my invention, I claim:

1. A bridge for the violin instrument, comprising:
a. a planed string bearing edge
b. a plurality of spaced string notches in a common plane on said edge whereby a violin player can play all strings simultaneously.
